(19) United States
(12) Patent Application Publication
(10) Pub. No.: US 2012/0221368 A1
(43) Pub. Date: Aug. 30, 2012

(54) PROCEDURE PLANNING TOOL FOR OFFICE APPOINTMENTS MANAGEMENT

(76) Inventors: Yang SUI, North York (CA); William MELEK, Toronto (CA); Joseph KURIAN, North York (CA)

(21) Appl. No.: 13/036,767

(22) Filed: Feb. 28, 2011

(51) Int. Cl. G06N 3/12; G06N 5/00; G06Q 10/00

(52) U.S. Cl. 705/7.17; 706/13; 706/45; 706/13

(57) ABSTRACT

Method and system for scheduling professional service procedures using artificial intelligence, specifically, using evolutionary search. Procedures can be scheduled optimally to achieve user defined goals and objectives. The method and system also optimizes future planning of professional service procedures and makes recommendations to the user on how to optimally deploy resources and professionals.

### FIELD OF INVENTION

The present invention relates to methods and systems for procedure planning and schedule optimization. In particular, the present invention relates methods and systems for planning and scheduling optimization of procedures and appointments using evolutionary search.

### BACKGROUND OF THE INVENTION

Computer programs for appointment scheduling have been known in the art. Users of such programs have been able to make their own respective schedules. In a group practice such as a medical office or in a clinic with several professionals, procedure appointments are usually scheduled by office personnel, in response to patients' or professionals' requests, for a large number of professionals and resources.

However, complicated procedures such as medical services involve many resources and different levels of each resource. Optimum planning and scheduling of complicated procedures is difficult to do manually. Furthermore, as a working day progresses, circumstances may occur that require modifications to the schedules in real time. For example, patients may call in for emergency appointments or cancellation; unanticipated delays may occur; medical history of a patient may indicate that he or she needs more or less than the allocated standard time slot. Sudden loss of resource may occur. At the present time it is very difficult, if not impossible, to reschedule complicated procedures optimally, at a short notice. Those circumstances can lead to major clinic disruption which inconvenience patients, possibly aggravating some patients' conditions. It is desirable, then, to have a system that can quickly and automatically plan an optimal schedule for procedures. It is also desirable to have a system identify resource bottlenecks and simulate different resource availability scenarios to help managers relieve those resource bottlenecks and better estimate the effects of changing his/her resource deployment before the costly change is made.

Scheduling and planning are traditionally very difficult problems to solve. Even scheduling of simple procedures with simple resource requirements can result in intractable NP-complete problems. For example, some manufacturing procedures may be simple but some medical services typically involve complicated procedures that require many resources and professionals. Those resources and professionals may not necessarily be occupied for the entire duration of a procedure. Take MRI scan appointment for example: much of the time in MRI appointments is spent preparing for the scan. The MRI scanner is not in use for the entire duration of the procedure. Professionals, nurses, technicians, radiologists, other resources, MRI scanner, change room, other equipment are all needed at different times during the procedure. The current state of the art models these kinds of procedures as solid blocks of resource consumption. I.e. for an MRI appointment, the nurse, technician, radiologist, MRI scanner, change room etc. are assumed to be fully occupied throughout the procedure. This does not allow overlapping of procedures and therefore forego opportunities for resource utilization optimization.

Ideally, a scheduling or planning system should model procedures with fine detail. An accurate scheduling planning model should not only capture what resources are needed but where in the procedure they are needed as well. Unfortunately, models of such fine detail are far more difficult to solve than simple scheduling problems.

Evolutionary search algorithms are particularly well suited to solving non-linear problems such as scheduling and planning that do not have any easily discernable patterns and steps to finding a good solution. U.S. Pat. No. 4,935,877 describes the general application of evolutionary algorithm to problem solving. U.S. Pat. No. 5,319,781 describes an application of evolutionary algorithm for schedule building.

### SUMMARY OF THE INVENTION

The present invention provides an automatic procedure planning tool for office appointments management. The present invention comprises of two modules: a scheduling module and a planning module.

The scheduling module models procedures that have complex resource and professional requirements. That is, resources or professionals may not necessarily be occupied for the entire duration of a procedure. Such procedures are each modelled as a series of tasks to be scheduled consecutively. The scheduling module also models precedence, pre-requisite, and mutual exclusion relationships between tasks. Solutions to the scheduling module comprises of queues of procedures to schedule. The solution that optimizes user specified objectives is found using an evolutionary search algorithm. The scheduling module converts solutions (i.e. procedures queues) into feasible schedules by automatically arranging procedures to avoid resource conflicts while maintaining precedence, pre-requisite, and mutual exclusion relationships between procedures. The scheduling module then outputs the generated procedures schedule to the user, along with automatically generated schedules of all resources and professionals associated with the scheduled procedures.

The planning module iterates the scheduling module to simulate different resource and professional availability scenarios. Results of such scenario simulation are analyzed. Those results and the associated analysis are outputted to the user. Based on those results and analysis, the planning module makes recommendations to the user on how to deploy resources to meet the user defined goal or objective.

The present invention also includes an apparatus and computer program that implements the scheduling, optimization, and planning methods previously described.

A computer implemented method for scheduling procedures involving professional services using evolutionary search, the said method comprising:
modeling and storing procedures with complex resource and professional requirements;
generating a population of possible solutions;
generating feasible schedules of procedures from solutions by automatically arranging procedures to avoid resource conflicts while maintaining precedence, prerequisite and/or mutual exclusion relationships;
evaluating schedules based on a user defined objective function;
running an evolutionary search algorithm to optimize a user defined objective function;
outputting the generated procedures schedule; and
automatically generating schedules for resources associated with the scheduled procedures.

The method described above, wherein a procedure has complex resource requirements.

The method described above, wherein a procedure has complex professional requirements.

The method described above, wherein a procedure has opportunities during its execution to be delayed to wait for required resources or professionals to become available.

The method described above, wherein a possible solution to the scheduling problem is a queue of procedures to schedule.

The method described above, wherein an initial population of solutions can be generated randomly or generated using fast, rule-based heuristics.

The method described above, wherein generating feasible schedules from possible solutions is done by delaying procedures, in the order encoded in a possible solution, until those procedures fit into time slots that are free from resource conflicts.

The method described above, wherein a queue repair function automatically arranges procedures in such an order that maintains precedence and pre-requisite relationships between tasks.

An apparatus for scheduling procedures involving professional services using evolutionary search.

The apparatus described above containing a single or multiple computer processors.

The apparatus described above containing memory for storing procedure information.

The apparatus described above containing memory for storing instructions or statements for use in executing the method of scheduling professional service procedures using evolutionary search.

The apparatus described above containing memory for temporarily storing populations of solutions to facilitate the evolutionary search.

The apparatus described above containing an evolutionary search algorithm that encodes potential solutions in a population and evolves that population to converge to and produce a near optimal solution.

The apparatus described above containing a schedule building system for generating feasible schedules from queues of procedures.

The apparatus described above containing a schedule building system for building schedules for all associated resources and professionals.

The apparatus described above containing one or more outputs to communicate all schedules to the user.

The apparatus described above, wherein a procedure has complex resource requirements.

The apparatus described above, wherein a procedure has complex professional requirements.

The apparatus described above, wherein a procedure has opportunities during its execution to be delayed to wait for required resources or professionals to become available.

A computer readable storage medium storing instructions or statements for use in the execution in a computer of a method of scheduling procedures involving professional services using evolutionary search, the method comprising:
modeling and storing procedures with complex resource and professional requirements;
generating a population of possible solutions;
generating feasible schedules of procedures from solutions by automatically arranging procedures to avoid resource conflicts while maintaining precedence, prerequisite and/or mutual exclusion relationships;
evaluating schedules based on a user defined objective function;
running an evolutionary search algorithm to optimize a user defined objective function;
outputting the generated procedures schedule; and
automatically generating schedules for resources associated with the scheduled procedures.

The medium described above, wherein a procedure has complex resource requirements.

The medium described above, wherein a procedure has complex professional requirements.

The medium described above, wherein a procedure has opportunities during its execution to be delayed to wait for required resources or professionals to become available.

The medium described above, wherein a possible solution to the scheduling problem is a queue of procedures to schedule.

The medium described above, wherein an initial population of solutions can be generated randomly or generated using fast, rule-based heuristics.

The medium described above, wherein generating feasible schedules from possible solutions is done by delaying procedures, in the order encoded in a possible solution, until those procedures fit into time slots that are free from resource conflicts.

The medium described above, wherein a queue repair function automatically arranges procedures in such an order that maintains precedence and pre-requisite relationships between tasks.

A computer program product comprising a memory having microcontroller-readable code embedded therein, when executed in a computer processor, causes the computer processor to perform a method of scheduling professional service procedures using evolutionary search, the method comprising:
modeling and storing procedures with complex resource and professional requirements;
generating a population of possible solutions;
generating a feasible schedule of procedures from each solution by automatically arranging procedures to avoid resource conflicts while maintaining precedence, prerequisite and/or mutual exclusion relationships;
evaluating schedules based on a user defined objective function;
running an evolutionary search algorithm to optimize a user defined objective function;
outputting the generated procedures schedule; and
automatically generating schedules for resources associated with the scheduled procedures.

A computer implemented method for automatically optimizing future planning of procedures involving professional services using artificial intelligence, the said method comprising the steps of:
modeling the overall resource and professional availability of a service provider;
modeling all professional service procedures that the service provider provides;
iterating an intelligent process of scheduling professional service procedures such as the method according to claim 1 and simulating different resource availability scenarios for said service provider;
iterating an intelligent process of scheduling professional service procedures such as the method according to claim 1 and simulating different professional availability scenarios for said service provider;
analyzing results of scenario simulation;
outputting results of scenario simulation;
making recommendations to user on how to optimally deploy resources to meet the user defined goals or objectives; and
making recommendations to user on how to optimally deploy professionals to meet the user defined goals or objectives.

An apparatus for optimizing future planning of professional service procedures using artificial intelligence.

The apparatus described above containing a single computer processor or multiple computer processors.

The apparatus described above containing memory for storing procedure information.

The apparatus described above containing memory for storing instructions or statements for use in execution in a computer of an intelligent method of scheduling professional service procedures such as the method outlined in claim 1.

The apparatus described above containing an intelligent system for scheduling procedures such as the method outlined in claim 1.

The apparatus described above containing outputs to communicate simulation results, analysis, and recommendations to the user.

A computer readable storage medium storing instructions or statements for use in the execution in a computer of a method for optimizing future planning of professional service procedures using artificial intelligence, the method comprising:
modeling the overall resource and professional availability of a service provider;
modeling all professional service procedures that the service provider provides;
iterating an intelligent process of scheduling professional service procedures such as the method according to claim 1 and simulating different resource availability scenarios for said service provider;
iterating an intelligent process of scheduling professional service procedures such as the method according to claim 1 and simulating different professional availability scenarios for said service provider;
analyzing results of scenario simulation;
outputting results of scenario simulation;
making recommendations to user on how to optimally deploy resources to meet the user defined goals or objectives; and
making recommendations to user on how to optimally deploy professionals to meet the user defined goals or objectives.

A computer program product comprising a memory having microcontroller-readable code embedded therein, when executed in a computer processor, causes the computer processor to perform a method for optimizing future planning of professional service procedures using artificial intelligence, the method comprising:
modeling the overall resource and professional availability of a service provider;
modeling all professional service procedures that the service provider provides;
iterating an intelligent process of scheduling professional service procedures such as the method according to claim 1 and simulating different resource availability scenarios for said service provider;
iterating an intelligent process of scheduling professional service procedures such as the method according to claim 1 and simulating different professional availability scenarios for said service provider;
analyzing results of scenario simulation;
outputting results of scenario simulation;
making recommendations to user on how to optimally deploy resources to meet the user defined goals or objectives; and
making recommendations to user on how to optimally deploy professionals to meet the user defined goals or objectives.

This summary of the invention does not necessarily describe all features of the invention.

### BRIEF DESCRIPTION OF THE DRAWINGS

FIG. 1 shows examples of complex procedures that the present invention is able to schedule.

FIG. 2 shows the resource conflict that complex procedures can have with each other.

FIG. 3A through FIG. 3E show the discretization of complex procedures into smaller, simple activities to facilitate modeling.

FIG. 4 shows the discretization of time into identically sized timeslots, into which activities and procedures can be slotted.

FIG. 5 shows examples of activity properties encoded in properties arrays of discretized activities.

FIG. 6 highlights the special gap activity at the beginning of a procedure to model the delay in scheduling of that procedure.

FIG. 7 shows the logic of resource conflict resolution. When resource conflicts are detected, one procedure is delayed until the earliest time when the resource conflicts are resolved.

FIG. 8 shows the encoding scheme of chromosomes used in the evolutionary search algorithm.

FIG. 9 shows an example of demand schedule for resource R6 extracted from the optimal procedures schedule found by the evolutionary algorithm.

FIG. 10 shows demand schedules of all resources extracted from the optimal procedures schedule found by the evolutionary algorithm.

FIG. 11 shows 10 identical procedures to be scheduled in an example scheduling problem.

FIG. 12 shows the initial attempt to schedule 10 procedures only fit 5 into the scheduling period. Indicates lack of resources to handle all 10 procedures.

FIG. 13 shows the doubling of resource R2 and the modification of a procedure to model the choice between resources R2a and R2b.

FIG. 14A and FIG. 14B show the modification of all procedures to model the choice between resources R2a and R2b. In effect, the problem now involves 2 instances each of the original 10 procedures. 1 instance uses resource R2a; the other instance uses resource R2b. This models different resource assignments and allows the scheduling module to choose the most optimal resource assignment.

FIG. 15 indicates that the addition of more resource R2 did not resolve the overall bottleneck and did not improve procedure throughput nor resource utilization.

FIG. 16 shows the doubling of resource R5 and the consequent modification of a procedure to reflect the choice between resource R5a and R5b. Implies that in effect, the problem now involves 4 instances each of the original 10 procedures. 1 instance uses resource R2a and R5a, 1 instance uses resource R2b and R5a, 1 instance uses resource R2b and R5b, and the remaining instance uses resource R2a and R5b.

FIG. 17 shows the resultant schedule from doubling resources R2 and R5. This figure shows that all resource bottlenecks are resolved and all 10 procedures are able to fit into the scheduling period, demonstrating effectiveness of the planning module.

### DETAILED DESCRIPTION

The following description is a preferred embodiment.

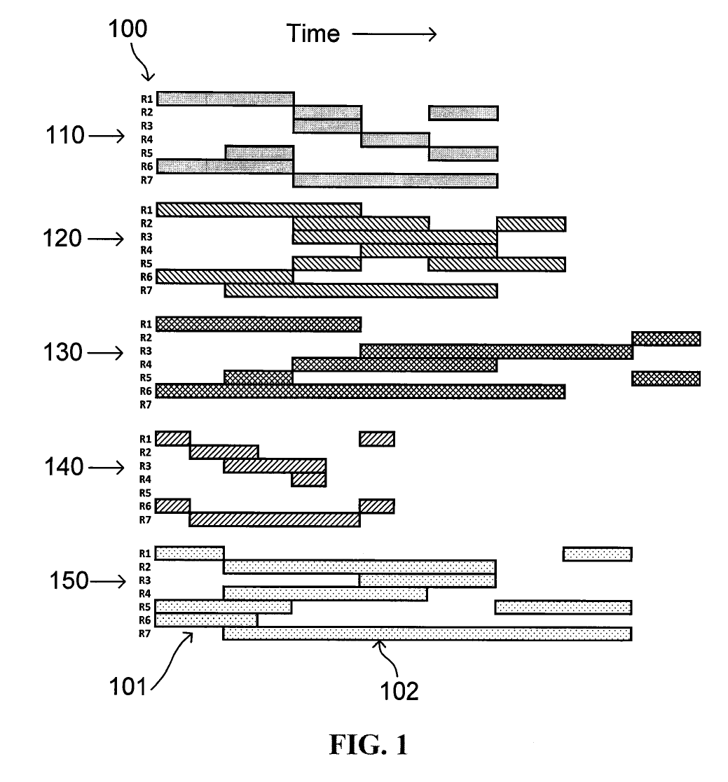

This preferred embodiment deals with procedures that have complex resource and professional requirements. FIG. 1 shows 5 examples of such complex procedures. In this example, the service provider has 7 resources or professionals: R1 through R7, indicated by reference character 100. Procedures designated by reference characters 110, 120, 130, 140, and 150 all have resource and/or professional requirements that may not be occupied through their entire durations. For example, procedure 150 does not need resource R7 near the beginning of execution. See reference character 101. Later in time however, resource R7 is needed and must be occupied as indicated by reference character 102.

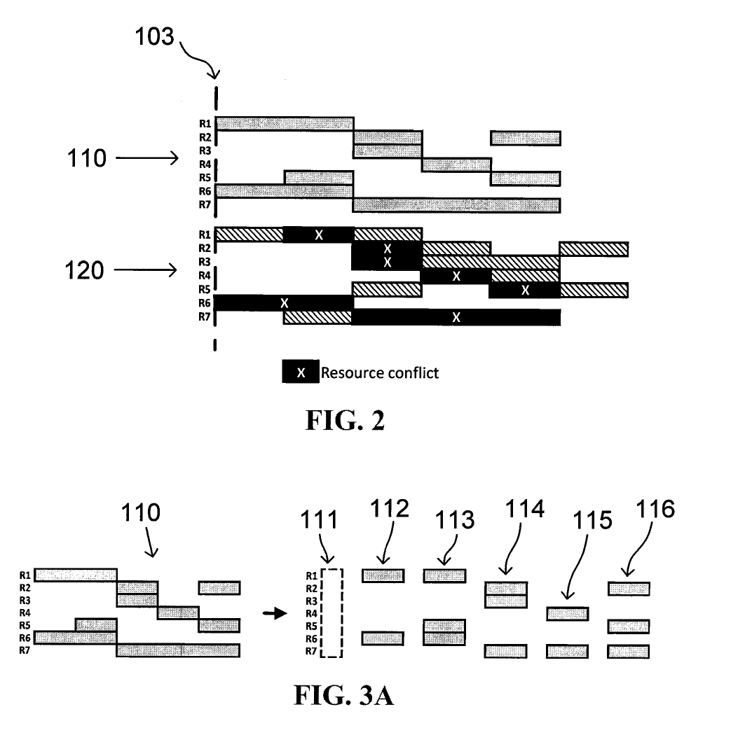

Complex procedures can lead to complex resource conflicts. FIG. 2 shows an example of resource conflicts resulting from attempting to schedule procedure 110 and 120 at the same starting time 103. This kind of complex resource conflict is one of the constraints in the present invention.

### Scheduling Module

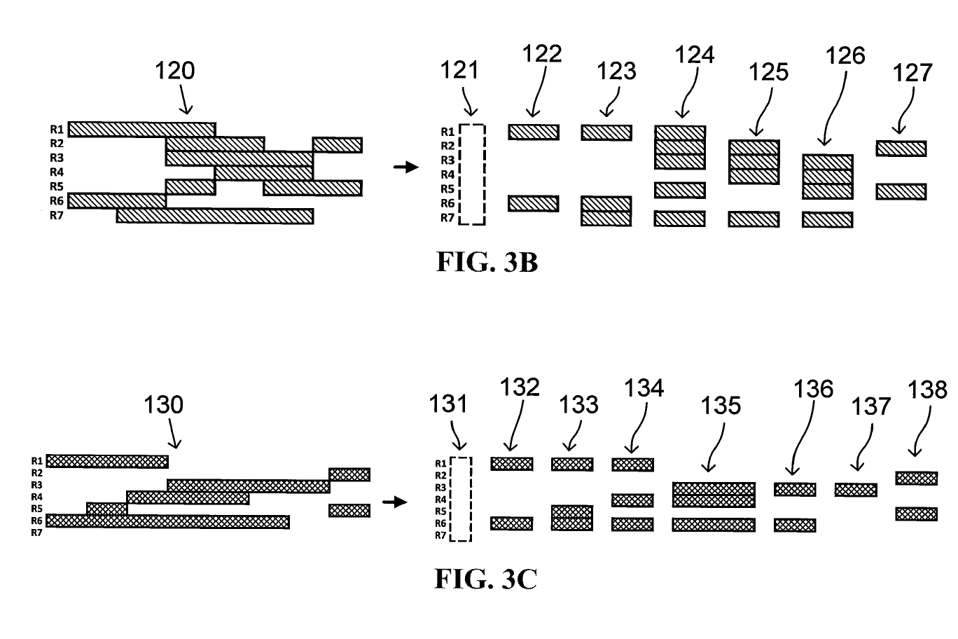

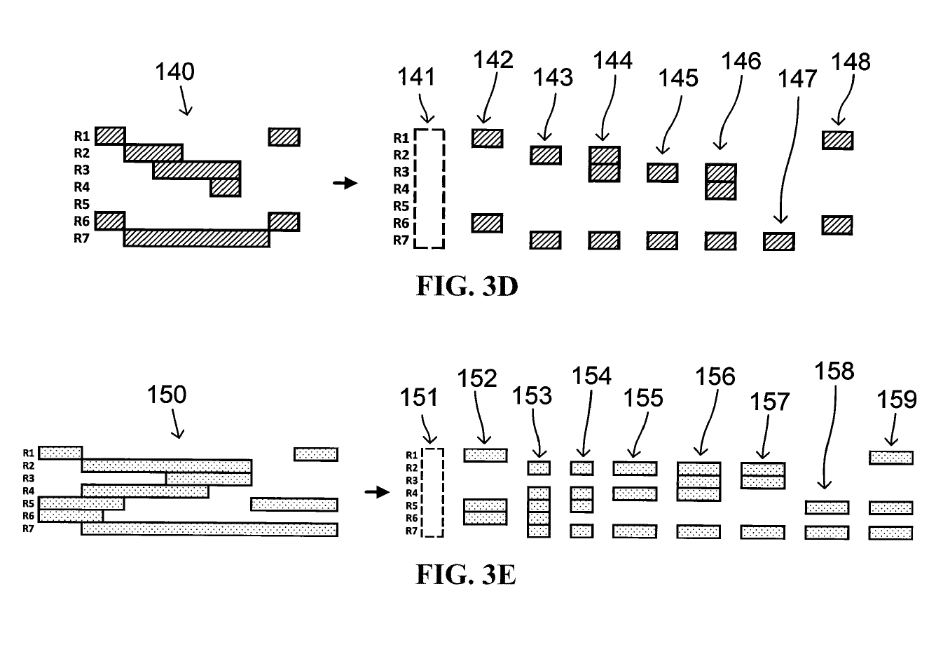

The strategy for modeling complex procedures is to discretize or break them down into simpler activities. FIG. 3A shows the discretization of procedure 110 into activities 111, 112, 113, 114, 115, and 116. The defining characteristic of the discretized activities is that each activity does not have complex resource requirements. That is, resources are occupied or consumed for the entire duration of an activity. Activities belonging to the same procedure are constrained to always be scheduled in the order that reconstitute that procedure when scheduled consecutively. Therefore, even though a procedure is discretized into simpler activities, those activities will always be scheduled together in a group. That group of activities will behave as a whole to mimic or model a complex procedure. FIG. 3B, FIG. 3C, FIG. 3D and FIG. 3E show the discretization of procedures 120, 130, 140, and 150 respectively.

Discretized activities are linked together with precedent and pre-requisite relationships. A precedent relationship between two activities means that one activity must immediately be scheduled at the completion of the other activity. All activities belonging to the same procedure are linked together with precedent relationships. For example, activity 111 in FIG. 3A is precedent to activity 112; activity 112 is precedent to activity 113; activity 113 is precedent to activity 114 and so on. The schedule builder enforces these precedent relationships to ensure that these activities accurately represent the procedure they are modeling. Pre-requisite relationship between two activities means that one activity may only be scheduled after its pre-requisite activity is completed but not necessarily immediately after. In this preferred embodiment, precedent and pre-requisite relationships between activities are captured in an N×N workflow matrix. Where N is the total number of activities the user is attempting to schedule at once. Each row and column represents an activity. Therefore, the workflow matrix encodes relationships between each activity and all other activities. That is, entry (i,j) encodes the relationship between activity i and activity j. The encoding scheme is as follows: (i,j)=0 means no relationship between activities i and j. (i,j)=1 means activity i is precedent to activity j. (i,j)=2 means activities i and j belong to the same procedure but do not have a precedent relationship with each other. (i,j)=3 means activity i is a pre-requisite to activity j. Storing of such a workflow matrix in a computer is a trivial matter.

Procedures may have precedent, pre-requisite, and mutual exclusion relationships. Precedent and pre-requisite relationships between procedures are automatically covered by precedent and pre-requisite relationships between activities of those procedures. Therefore, separate relationship connection between procedures is not required. The mutual exclusion relationship, however, applies only to procedures and specifies that one or the other procedure can be scheduled but not both. This mutual exclusion relationship is used to enable the resource assignment optimization feature of this present invention. More details in a later section of this detailed description of the preferred embodiment.

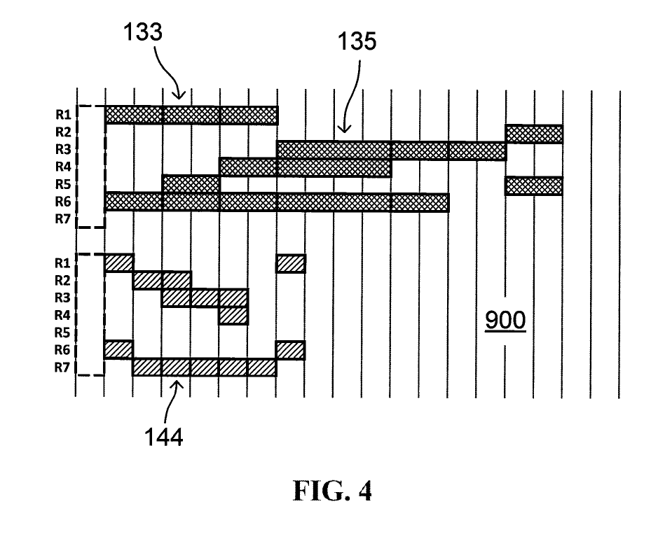

In addition to the discretization of complex procedures into simple activities, the scheduling period must be discretized into identically sized timeslots. The time slots should ideally be sized to the maximum length that is a common denominator of duration lengths of all activities in the current model. Activities must fit completely in timeslots or multiples of timeslots. Assume, in the FIG. 4 example that the timeslot size is set to the largest common denominator of all activity durations: 5 minutes. A 5 minute activity such as activity 144 fully occupies 1 timeslot; a 10 minute activity such as activity 133 fully occupies 2 timeslots; and a 20 minute activity such as activity 135 fully occupies 4 timeslots. The key requirement is that activities fully occupy integer multiples of timeslots. Therefore, timeslot length may be set at any common integer denominator of all activity durations. For example, the timeslots in FIG. 4 can be set to 1 minute in length. This length however, is unnecessary and will lead to excessive computational cost. The preferred embodiment sets the timeslot size at the largest common integer denominator of all activity durations.

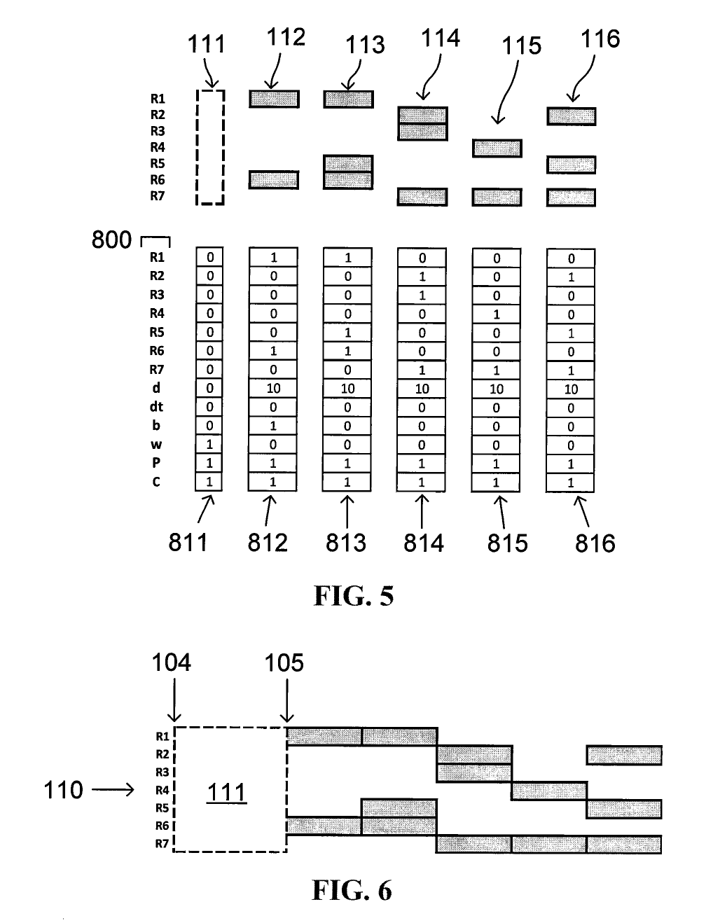

The discretization of complex procedures into simple activities and discretization of the scheduling period into timeslots allows a simple encoding scheme to represent and store the model in a computer. Each activity has associated with it the following properties: resource requirements, duration, due time, user defined objective coefficients as well as index properties to track which procedure an activity belongs to and which customer that activity serves. FIG. 5 shows example properties arrays for procedure 110. Reference character 800 marks property array headings. R1 through R7 encode resource requirements. A value of 1 indicates that that resource is required, 0 if it is not. For example, the R6 value of property array 813 is 1. This means that activity 113 requires resource R6. Property array heading “d” indicates activity duration in minutes or whatever common time unit the user prefers. Heading “dt” indicates activity due time in minutes (or time units) since the beginning of the scheduling period. Headings “b” and “w” are examples of user defined objective coefficients: “benefit” and “wait time penalty.” Benefit represents the importance of scheduling the associated activity in the current scheduling period. Wait time penalty represents the relative cost of delaying the associated activity. Objective coefficients are coefficients on variables in the objective function. The objective function, described in a later section, is the standard to which the quality of a scheduled is evaluated. Objective coefficients therefore encode the user's preferences and criteria. The benefit and wait time penalty objective coefficients are simply examples found in the preferred embodiment. They do not limit the possibility of more advanced objective coefficients. Property heading “P” indicates the index of the procedure that an activity belongs to. All activities in FIG. 5 belong to procedure with an index of 1. The index value is arbitrary, as long as the value representing each procedure is distinct enough to distinguish that procedure from all other procedures. Property heading “C” indicates the index of the customer that an activity serves. All activities in FIG. 5 serve customer 1. The customer index value is arbitrary, as long as the value representing each customer is distinct enough to distinguish that customer from all other customers. The mutual exclusion relationship between procedures is encoded in the combination of procedure index and customer index properties. That is, if all activities of, say, procedure 1 serve customer 1 and all activities of procedure 2 also serve customer 1, then procedures 1 and 2 are considered mutually exclusive. Only one procedure may serve one distinct customer. The scheduling module has built-in checks that ensure all customers are served by only one procedure.

Properties arrays comprise of simple integers. They may be stored in a computer in many ways ranging from plain text files to relational databases. Any person of ordinary skill in the art can design a storage solution suitable to his or her needs.

Activity 111 shown in FIG. 3A is an example of a special “gap activity.” A gap activity has flexible duration and models the delay that a procedure can experience between its due time and its actual scheduled starting time. FIG. 6 shows the gap activity 111 for example procedure 110. The beginning of gap activity 111 represents procedure 110's due time. See reference character 104. The end of gap activity 111 represents the actual time that procedure 110 is scheduled. See reference character 105. Gap activities may have resource requirements and can therefore represent the occupation of a resource while a procedure is being delayed. An example could be a person waiting in a room for a professional to become available to provide a service. The room is a resource required by the gap activity that models the waiting period.

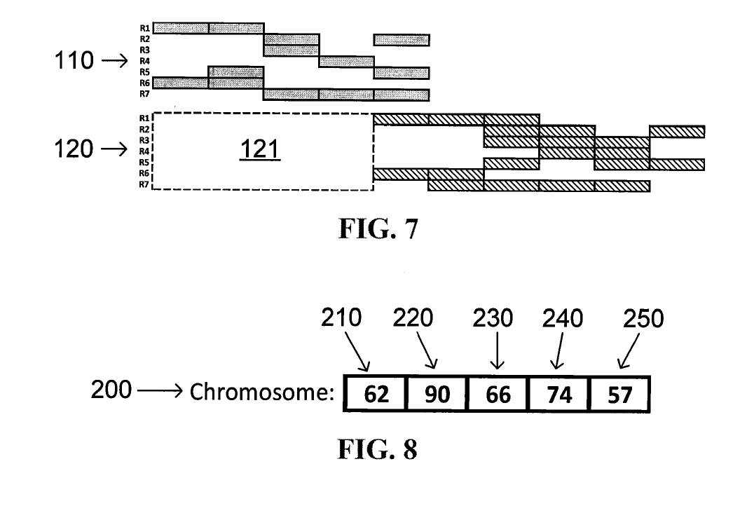

The resolution of resource conflicts is achieved by adjusting the delays (i.e. changing durations of gap activities) of all procedures involved. Recall the resource conflict between procedures 110 and 120 depicted in FIG. 2, that conflict scenario can be resolved by delaying the scheduling of procedure 120. FIG. 7 shows the minimum time procedure 120 must be delayed by (i.e. minimum duration of gap activity 121) to resolve resource conflict between procedures 110 and 120.

Procedures are added to a schedule on a first come first serve basis. In the FIG. 7 example, procedure 110 is assumed to have come first. Therefore, it is procedure 120 that must be delayed to resolve the resource conflict. The order of procedures to add to a schedule is guided by priority values associated with each procedure. Procedures are added to a schedule in an order of descending priority values. A queue of procedure priority values represents a potential solution to the scheduling problem this invention attempts to solve.

The tool for solving the scheduling problem is evolutionary algorithm (EA). EA encodes strings of solutions in chromosomes. FIG. 8 shows an example chromosome 200 encoding a solution (or queue) to the present scheduling problem. Each element, called allele, of a chromosome encodes a priority value of a procedure. For chromosome 200 in FIG. 8, allele 210 encodes the priority value of procedure 110. Alleles 220, 230, 240, and 250 encode priority values of procedures 120, 130, 140, and 150 respectively. Chromosomes are decoded by sorting allele values in descending order. Sorting the allele values of example chromosome 200 reveals the following scheduling order: procedure 120, 140, 130, 110, and then 150.

Scheduling queues encoded in chromosomes are converted into schedules by a schedule builder. The schedule builder first passes a chromosome through a repair function. The repair function rearranges alleles (priority) values to manipulate the scheduling order to enforce precedent, pre-requisite, and mutual exclusion relationships. For example, a procedure has a higher priority value than (therefore is trying to be scheduled ahead of) its pre-requisite procedure, the repair function will swap the priority values of those two procedures. Similar repair is carried out for precedent relationship violations. Mutual exclusion relationships are enforced thusly: the repair function checks all procedures involved in a mutual exclusion relationship, identifies the procedure with the highest priority value, and then set priority values of remaining procedures to −1 to signal the schedule builder to ignore those procedures. This description of the repair function is merely the preferred embodiment. This does not limit more advanced repair methods or algorithms. Next, the schedule builder assembles a schedule by slotting activities of each procedure into the earliest possible time that does not cause resource conflicts. This slotting is accomplished by delaying procedures like the example shown in FIG. 7 in the order encoded in the chromosome. Finally, the schedule builder evaluates the resultant schedule against a user defined objective function and obtains a fitness value (or score) representing the quality of that schedule. An objective function may contain criteria such as total wait time, average wait time, maximum wait time, patient throughput, and/or resource utilization. The user may set the desired weighting on each criterion to reflect the relative importance of each criterion to overall schedule quality. For example, the objective function of the current preferred embodiment evaluates the quality of a schedule as the total benefit of scheduling procedures less the total cost of their delays or waiting times.

A schedule of highest possible quality is the optimal solution to this scheduling problem. The search for that optimal solution is accomplished using a evolutionary algorithm (EA). The EA begins with an initial population of chromosomes encoding potential solutions. The initial population should be generated randomly. The initial population can also be seeded with high quality chromosomes created using some rule-based heuristic scheduling algorithms. Such heuristic scheduling algorithms may follow simple rules such as scheduling shorter duration procedures earlier; scheduling procedures with most complex resource requirements earlier; or any problem specific rules that the user may specify. In the simplest embodiment of this invention, the initial chromosome population is generated randomly.

As its name suggests, EA searches for the optimal solution by evolving the population. EA applies chromosome operations such as cross over, recombination and mutation to chromosomes at each successive generation. The population is updated at each generation. Fitter chromosomes resulting from chromosome operations replace weak chromosomes in the population. This survival of the fittest evolution continues until certain termination criteria are met. Example termination criteria are: maximum number of generations, population convergence, or minimum fitness level achieved. The maximum number of generations criterion simply stops the evolutionary process when that generations limit is reached. The population convergence criterion stops the evolutionary process if average population fitness remains constant for a number of generations indicating that the population is no longer evolving. The minimum fitness level criterion stops the evolutionary process as soon as a solution is found that meets or exceeds the minimum fitness level specified by the user. The preferred embodiment uses the population convergence termination criterion.

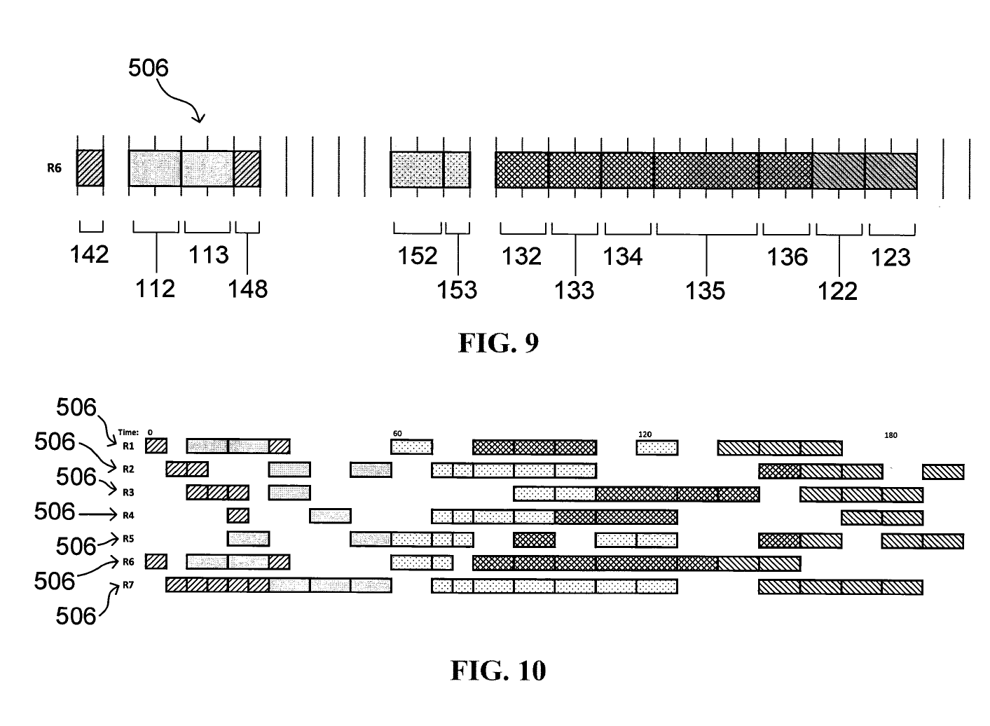

The schedule builder translates the optimal solution found by the EA into a schedule of procedures. From that schedule is extracted the demand for all resources. Schedules of each individual resource can be built from resource demand information extracted from the procedures schedule. FIG. 9 shows an example of a demand schedule for resource R6. As the demand schedule 506 shows, resource R6 is scheduled to serve or carry out activities 142, 112, 113, 148, 152, 153, 132, 133, 134, 135, 136, 122, and then 123 at the indicated time slots. Similar demand schedules for all other resources can easily be extracted from the main procedures schedule. FIG. 10 shows demand schedules of each resource in this example procedures schedule.

### Planning Module

The planning module of the preferred embodiment intelligently iterates the scheduling module to optimize user defined objectives. Example objectives are identifying bottlenecks, maximizing resource utilization and optimizing procedure throughput.

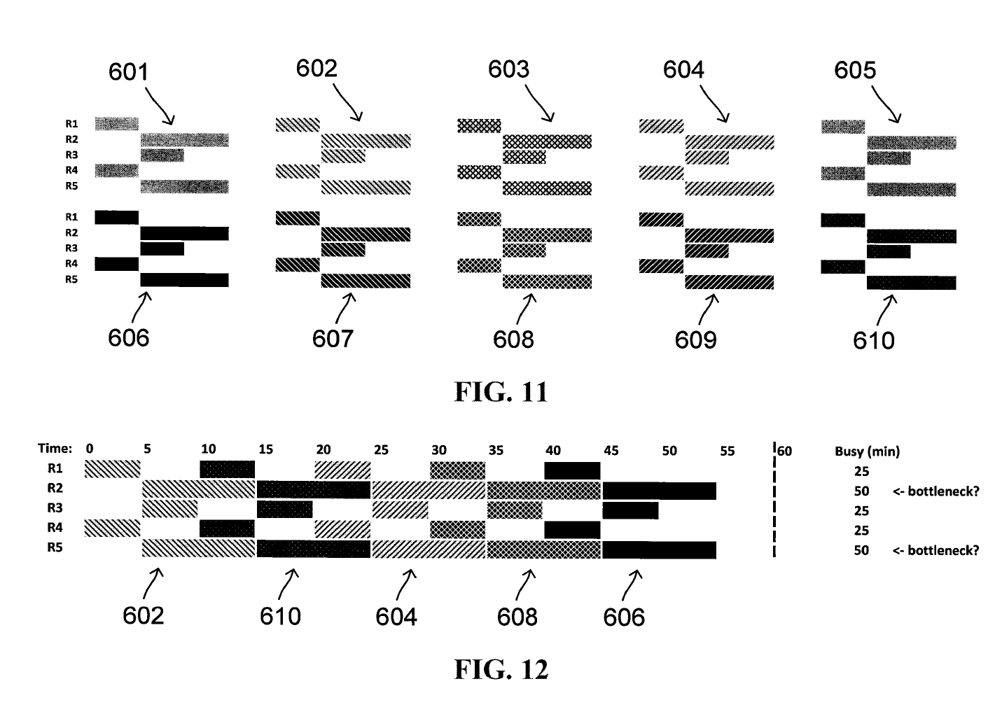

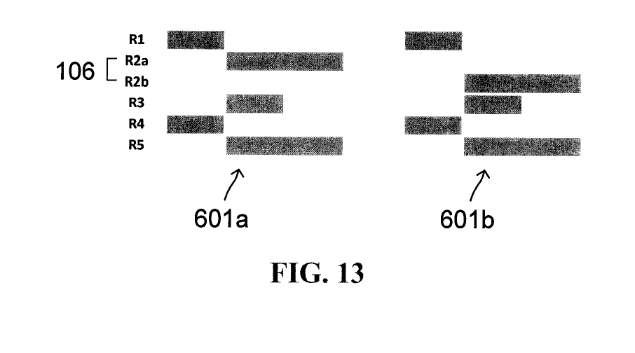

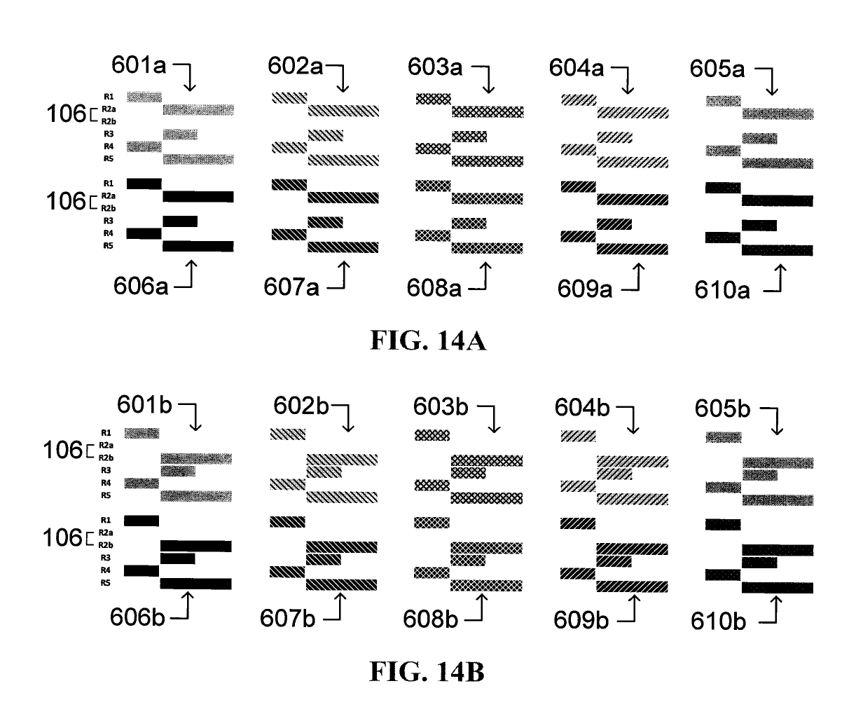

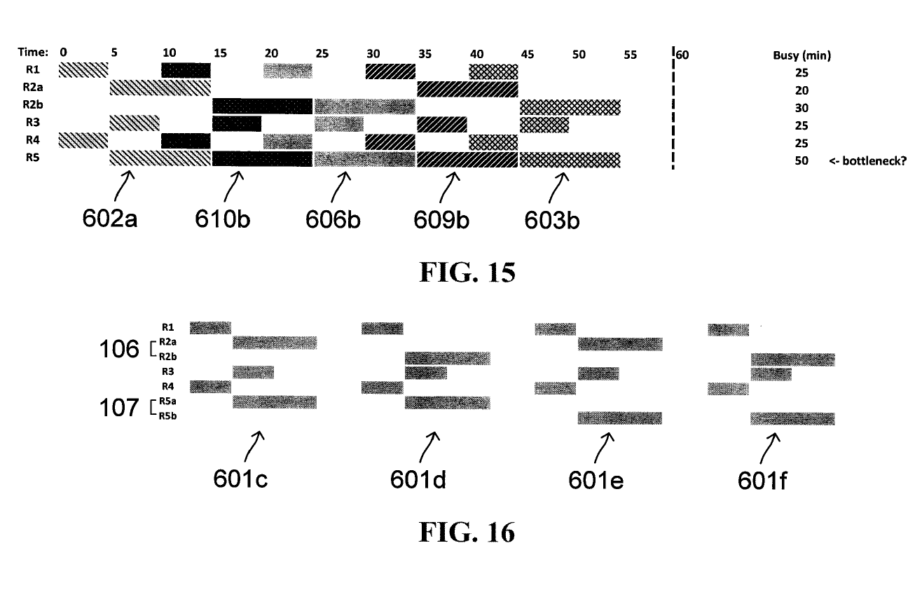

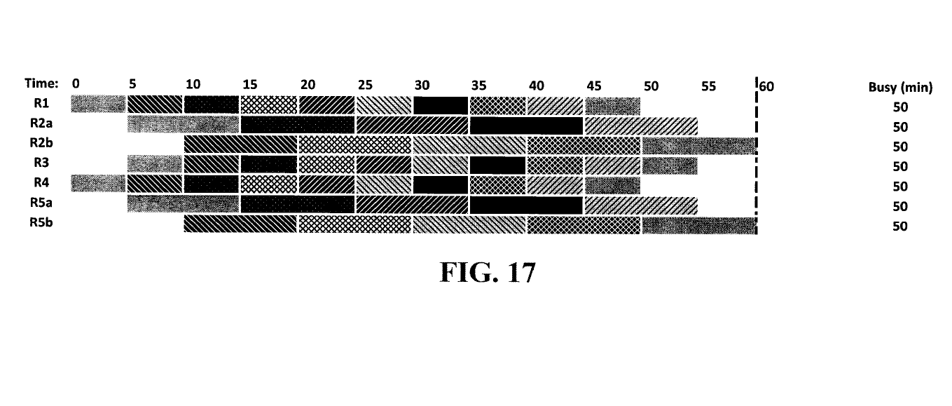

Resource bottlenecks are easy to identify from resource demand schedules extracted from the main procedures schedule. To illustrate this planning module, consider the problem of scheduling 10 identical example procedures as shown in FIG. 11 into a 60 minute scheduling period. As FIG. 12 shows, the scheduling module was only able to fit 5 procedures into the scheduling period. That is, the procedures throughput is 5. Resource R2 and R5 are the busiest, each occupied for 50 minutes while all other resources are only occupied for 25 minutes. To relieve bottlenecks, the planning module modifies the procedures model to add more of the bottleneck resource. For example, the planning module doubles resource R2 into resources R2a and R2b as shown by reference character 106 in FIG. 13. The doubling of resource R2 necessitates the reassignment of resource R2 to each procedure. The planning module modifies the procedures model by modeling two instances of each procedure. One instance is assigned resource R2a, the other instance is assigned resource R2b. The two example instances, 601a and 601b of procedure 601 are shown in FIG. 13. Two instances of all procedures are modeled to reflect this freedom of choice between resources R2a and R2b. FIG. 14A shows the instance of each procedure assigned to resource R2a. FIG. 14B shows the instance of each procedure assigned to resource R2b. Between the two instances of each procedure is established a mutual exclusion relationship. That is, if one instance is scheduled, the other must not be scheduled. This models the choice of different allocations of the additional resource R2b and allows the scheduling module to choose the instance that will result in the optimal schedule, thereby identifying the most optimal resource assignments. The schedule resultant from adding an additional instance of resource R2 is shown in FIG. 15. The resource R2 bottleneck is relieved but resource R5 is still a bottleneck. The relieving of resource R2 bottleneck did not improve procedure throughput. The resource R5 bottleneck is still limiting the total number of procedure scheduled to only 5. The planning module further modifies the model to simulate the addition of more resource R5 to attempt to relieve that bottleneck. 4 instances of each procedure are modeled to represent the combination of possible resource assignments between the 2 instances each of resource R2 and R5. The 4 instances of procedure 601 are shown in FIG. 16 as well as the 2 instances each of resource R2 and R5 indicated by reference characters 106 and 107 respectively. Mutual exclusion relationships must be established between the 4 instances of each procedure. FIG. 17 shows the resultant schedule built from the modified model with additional resources R2 and R5. All resource bottlenecks have been relieved and the procedure throughput has doubled to 10 procedures. Consequently, resource utilization for all resources improved to 50 minutes. The planning module may continue repeating this process of identifying bottlenecks then simulating the effect of doubling that bottleneck resource until all user defined objectives have been met. In this case, all the procedures that the user wants to schedule have been scheduled. Therefore the simulation stops. Examples of user defined objective may be: minimum utilization level, maximum average wait time, maximum individual wait time, minimum procedures throughput etc.

The planning module automates this illustrated method of bottleneck identification and optimization and presents the results to the user. The preferred embodiment presents all steps of the simulation and results to the user. In this example, the planning module presents first the step of adding additional resource R2 and the result. Next the planning module presents the step of increasing both resource R2 and R5 and the result. The user is then left with the choice of which step or recommendation to implement. In this example, adding more resource R2 did not improve procedure throughput while adding more of both resources R2 and R5 doubled procedure throughput so the choice of which recommendation to implement is clear. However, the optimization of more complicated procedures over longer scheduling periods may yield many simulation steps and recommendations. The user may then subject those recommendations to his/her own judgment, preferences, or other intangible criteria that are impossible to formalize mathematically or logically.

The embodiment of the present invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor receives instructions and data from a read-only memory and/or a random access memory. Generally, a computer includes one or more mass storage devices for storing data files. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). Further, a computer data signal representing the software code which may be embedded in a carrier wave may be transmitted via a communication network. Such a computer readable memory and a computer data signal are also within the scope of the present invention, as well as the hardware, software and the combination thereof.

The present invention has been described with regard to one or more embodiments. However, it should be apparent to persons skilled in the art that a number of variations and modifications can be made without departing from the scope of the invention as defined in the claims.

What is claimed is:

1. A computer implemented method for scheduling procedures involving professional services using evolutionary search, the said method comprising:
modeling and storing procedures with complex resource and professional requirements;
generating a population of possible solutions;
generating feasible schedules of procedures from solutions by automatically arranging procedures to avoid resource conflicts while maintaining precedence, prerequisite and/or mutual exclusion relationships;
evaluating schedules based on a user defined objective function;
running an evolutionary search algorithm to optimize a user defined objective function;
outputting the generated procedures schedule; and
automatically generating schedules for resources associated with the scheduled procedures.

2. The method according to claim 1, wherein a procedure has complex resource requirements.

3. The method according to claim 1, wherein a procedure has complex professional requirements.

4. The method according to claim 1, wherein a procedure has opportunities during its execution to be delayed to wait for required resources or professionals to become available.

5. The method according to claim 1, wherein a possible solution to the scheduling problem is a queue of procedures to schedule.

6. The method according to claim 1, wherein an initial population of solutions can be generated randomly or generated using fast, rule-based heuristics.

7. The method according to claim 1, wherein generating feasible schedules from possible solutions is done by delaying procedures, in the order encoded in a possible solution, until those procedures fit into time slots that are free from resource conflicts.

8. The method according to claim 1, wherein a queue repair function automatically arranges procedures in such an order that maintains precedence and pre-requisite relationships between tasks.

9. An apparatus for scheduling procedures involving professional services using evolutionary search.

10. The apparatus in claim 8 containing a single or multiple computer processors.

11. The apparatus in claim 8 containing memory for storing procedure information.

12. The apparatus in claim 8 containing memory for storing instructions or statements for use in executing the method of scheduling professional service procedures using evolutionary search.

13. The apparatus in claim 8 containing memory for temporarily storing populations of solutions to facilitate the evolutionary search.

14. The apparatus in claim 8 containing an evolutionary search algorithm that encodes potential solutions in a population and evolves that population to converge to and produce a near optimal solution.

15. The apparatus in claim 8 containing a schedule building system for generating feasible schedules from queues of procedures.

16. The apparatus in claim 8 containing a schedule building system for building schedules for all associated resources and professionals.

17. The apparatus in claim 8 containing one or more outputs to communicate all schedules to the user.

18. The apparatus according to claim 8, wherein a procedure has complex resource requirements.

19. The apparatus according to claim 8, wherein a procedure has complex professional requirements.

20. The apparatus according to claim 8, wherein a procedure has opportunities during its execution to be delayed to wait for required resources or professionals to become available.

21. A computer readable storage medium storing instructions or statements for use in the execution in a computer of a method of scheduling procedures involving professional services using evolutionary search, the method comprising:
modeling and storing procedures with complex resource and professional requirements;
generating a population of possible solutions;
generating feasible schedules of procedures from solutions by automatically arranging procedures to avoid resource conflicts while maintaining precedence, prerequisite and/or mutual exclusion relationships;
evaluating schedules based on a user defined objective function;
running an evolutionary search algorithm to optimize a user defined objective function;
outputting the generated procedures schedule; and
automatically generating schedules for resources associated with the scheduled procedures.

22. The medium according to claim 21, wherein a procedure has complex resource requirements.

23. The medium according to claim 21, wherein a procedure has complex professional requirements.

24. The medium according to claim 21, wherein a procedure has opportunities during its execution to be delayed to wait for required resources or professionals to become available.

25. The method according to claim 21, wherein a possible solution to the scheduling problem is a queue of procedures to schedule.

26. The method according to claim 21, wherein an initial population of solutions can be generated randomly or generated using fast, rule-based heuristics.

27. The method according to claim 21, wherein generating feasible schedules from possible solutions is done by delaying procedures, in the order encoded in a possible solution, until those procedures fit into time slots that are free from resource conflicts.

28. The method according to claim 21, wherein a queue repair function automatically arranges procedures in such an order that maintains precedence and pre-requisite relationships between tasks.

29. A computer program product comprising a memory having microcontroller-readable code embedded therein, when executed in a computer processor, causes the computer processor to perform a method of scheduling professional service procedures using evolutionary search, the method comprising:
modeling and storing procedures with complex resource and professional requirements;
generating a population of possible solutions;
generating a feasible schedule of procedures from each solution by automatically arranging procedures to avoid resource conflicts while maintaining precedence, prerequisite and/or mutual exclusion relationships;
evaluating schedules based on a user defined objective function;
running an evolutionary search algorithm to optimize a user defined objective function;
outputting the generated procedures schedule; and
automatically generating schedules for resources associated with the scheduled procedures.

30. A computer implemented method for automatically optimizing future planning of procedures involving professional services using artificial intelligence, the said method comprising the steps of:
modeling the overall resource and professional availability of a service provider;
modeling all professional service procedures that the service provider provides;
iterating an intelligent process of scheduling professional service procedures such as the method according to claim 1 and simulating different resource availability scenarios for said service provider;
iterating an intelligent process of scheduling professional service procedures such as the method according to claim 1 and simulating different professional availability scenarios for said service provider;
analyzing results of scenario simulation;
outputting results of scenario simulation;
making recommendations to user on how to optimally deploy resources to meet the user defined goals or objectives; and
making recommendations to user on how to optimally deploy professionals to meet the user defined goals or objectives.

31. An apparatus for optimizing future planning of professional service procedures using artificial intelligence.

32. The apparatus in claim 31 containing a single computer processor or multiple computer processors.

33. The apparatus in claim 31 containing memory for storing procedure information.

34. The apparatus in claim 31 containing memory for storing instructions or statements for use in execution in a computer of an intelligent method of scheduling professional service procedures such as the method outlined in claim 1.

35. The apparatus in claim 31 containing an intelligent system for scheduling procedures such as the method outlined in claim 1.

36. The apparatus in claim 31 containing outputs to communicate simulation results, analysis, and recommendations to the user.

37. A computer readable storage medium storing instructions or statements for use in the execution in a computer of a method for optimizing future planning of professional service procedures using artificial intelligence, the method comprising:
modeling the overall resource and professional availability of a service provider;
modeling all professional service procedures that the service provider provides;
iterating an intelligent process of scheduling professional service procedures such as the method according to claim 1 and simulating different resource availability scenarios for said service provider;
iterating an intelligent process of scheduling professional service procedures such as the method according to claim 1 and simulating different professional availability scenarios for said service provider;
analyzing results of scenario simulation;
outputting results of scenario simulation;
making recommendations to user on how to optimally deploy resources to meet the user defined goals or objectives; and
making recommendations to user on how to optimally deploy professionals to meet the user defined goals or objectives.

38. A computer program product comprising a memory having microcontroller-readable code embedded therein, when executed in a computer processor, causes the computer processor to perform a method for optimizing future planning of professional service procedures using artificial intelligence, the method comprising:
modeling the overall resource and professional availability of a service provider;
modeling all professional service procedures that the service provider provides;
iterating an intelligent process of scheduling professional service procedures such as the method according to claim 1 and simulating different resource availability scenarios for said service provider;
iterating an intelligent process of scheduling professional service procedures such as the method according to claim 1 and simulating different professional availability scenarios for said service provider;
analyzing results of scenario simulation;
outputting results of scenario simulation;
making recommendations to user on how to optimally deploy resources to meet the user defined goals or objectives; and
making recommendations to user on how to optimally deploy professionals to meet the user defined goals or objectives.
